(19) United States
(12) Patent Application Publication
(10) Pub. No.: US 2016/0160776 A1
(43) Pub. Date: Jun. 9, 2016

(54) Engine System and Method

(71) Applicant: Caterpillar Inc., Peoria, IL (US)

(72) Inventors: Mary L. Yeager, Lafayette, IN (US); Francis L. Clark, Pekin, IL (US); Brandon Gregory, Peoria, IL (US)

(73) Assignee: Caterpillar Inc., Peoria, IL (US)

(21) Appl. No.: 14/563,337

(22) Filed: Dec. 8, 2014

(51) Int. Cl. F02D 41/14; F02D 35/02; F02D 37/02; F02D 41/30; F02P 17/02

(52) U.S. Cl. CPC F02D 41/1444; F02D 41/1477; F02D 41/3005; F02D 41/1443; F02P 17/02; F02D 37/02; F02D 35/023

(57) ABSTRACT

A pressure sensor disposed to sense an engine cylinder pressure provides a pressure signal, and an engine timing sensor provides an engine timing signal to an electronic controller, which is programmed to receive and analyze the pressure and engine timing signals to determine a misfire signal, a peak pressure signal, a pressure rise rate, an actual ignition signal, and a center of combustion signal. The electronic controller is further programmed to activate a fault flag when at least one of the misfire signal, the peak pressure signal, the pressure rise rate, the actual ignition signal, and the center of combustion signal, indicates that an abnormal combustion is present in the cylinder.

### TECHNICAL FIELD

This disclosure relates generally to internal combustion engines and, more particularly, to systems and methods for diagnosis of in-cylinder combustion quality.

### BACKGROUND

Internal combustion engines have many components that can affect the reliable and efficient operation of the engine. Engine operation and performance may be especially affected by the condition of those components that are associated with the engine's combustion cylinders such as intake and exhaust valves, piston rings, head gaskets and the like. Failures can occur for various reasons, such as thermal cycling, fatigue and the like. When such components fail, or their performance is compromised by a less than complete failure, the effects of such failure may not be immediately apparent to the engine's operator. However, such failures may cause a reduction in engine power, loss of sufficient sealing of the engine's combustion cylinder, increased oil consumption, decreased fuel economy, and other effects.

Even in the absence of a component-related condition, in-cylinder engine combustion may be further affected by various environmental factors such as ambient air temperature, barometric pressure, fuel quality, engine core temperature, and other factors. Such environmental factors, in addition to or instead of engine component conditions, may result in issues with engine combustion including misfire, detonation of the fuel/air mixture, and/or pre-ignition. Apart from adversely affecting engine fuel consumption, noise, roughness, emissions, and power output, improper combustion can also result in premature engine component failure, engine starting issues, and others.

The detection and diagnosis of abnormal engine combustion is a time consuming task because it traditionally entails running the engine in a diagnostic or service mode with instrumentation added to the engine to detect abnormalities. Moreover, fuel abnormal combustion that is imperceptible to the user may go undetected. In the past, various attempts have been made to diagnose such engine conditions during normal engine operation by use of accelerometers or other, secondary measurements, such as fluctuations in engine torque or power output, fluctuations in engine intake or exhaust pressure, and others, with mixed results.

One previously proposed solution for detecting and diagnosing abnormal engine combustion can be seen in U.S. Pat. No. 8,677,975, which is entitled “Method for Detection of Abnormal Combustion for Internal Combustion Engines.” The method for detecting abnormal combustion described in this reference includes modeling cylinder pressure development as a function of crankshaft rotation to estimate cylinder pressure, measuring cylinder pressure, and comparing the measured cylinder pressure with the estimated cylinder pressure to determine the amplitude of a pre-ignition in the cylinder, which amplitude is used to control the pre-ignition. The pre-ignition is a type of abnormal combustion that can occur at low engine speeds or under very high loads. Although this approach is at least partly effective in detecting pre-ignition, it does not address other types of abnormal combustion nor is it effective over the entire engine operating range.

### SUMMARY

In one aspect, the disclosure describes an internal combustion engine. The internal combustion engine has a cylinder, a piston reciprocally disposed within a cylinder bore formed in a cylinder block, a crankshaft connected to the piston such that reciprocal motion of the piston results in rotational motion of the crankshaft, one or more piston ring seals connected to the piston and disposed between the piston and the cylinder bore to sealably and slidingly engage the cylinder bore, a cylinder head disposed to block an open end of the cylinder bore, a combustion chamber defined within the cylinder bore between the piston and the cylinder head, an intake valve disposed to selectively open such that the combustion chamber is fluidly connected with an intake manifold, and an exhaust valve disposed to selectively open such that the combustion chamber is fluidly connected with an exhaust collector.

In one embodiment, the internal combustion engine further includes a pressure sensor disposed to sense a cylinder pressure directly within the combustion chamber and to provide a pressure signal, which pressure signal is indicative of the cylinder pressure. An engine timing sensor is disposed to sense an angle of a rotating component of the engine and to provide an engine timing signal, which engine timing signal is indicative of a position of the piston within the cylinder bore. The internal combustion engine further includes an electronic controller programmed to receive the pressure signal from the pressure sensor, receive the engine timing signal from the engine timing sensor, and analyze the pressure signal and the engine timing signal to determine at least one of a misfire signal, a peak pressure signal, a pressure rise rate, an actual ignition signal, and a center of combustion signal. The electronic controller is further programmed to activate a fault flag when at least one of the misfire signal, the peak pressure signal, the pressure rise rate, the actual ignition signal, and the center of combustion signal, indicates that an abnormal combustion is present in the cylinder.

In another aspect, the disclosure describes a method for diagnosing abnormal combustion in a cylinder of an internal combustion engine. The method includes monitoring a pressure signal, which is indicative of a fluid pressure within a combustion chamber of the internal combustion engine, and also monitoring an engine timing signal, which engine timing signal is indicative of a rotation of an output shaft of the internal combustion engine and is also indicative of a position of a piston within the cylinder. The pressure signal from the pressure sensor is received in an electronic controller, and the engine timing signal is also received from the engine timing sensor in the electronic controller. The pressure signal and the engine timing signal are analyzed using the electronic controller during normal engine operation to determine, in real time, at least one of a misfire signal, a peak pressure signal, a pressure rise rate, an actual ignition signal, and a center of combustion signal. The electronic controller activates a fault flag when the at least one of the misfire signal, the peak pressure signal, the pressure rise rate, the actual ignition signal, and the center of combustion signal, indicates that an abnormal combustion is present in the cylinder.

### BRIEF DESCRIPTION OF THE DRAWINGS

FIG. 1 is a block diagram representation of an internal combustion engine in accordance with the disclosure.

FIG. 2 is a detailed, enlarged view of a combustion cylinder of an engine, which is shown in cross section, in accordance with the disclosure.

FIG. 3 is qualitative graph showing a pressure trace within a combustion cylinder in accordance with the disclosure.

FIG. 4 is a block diagram for an abnormal combustion detection system in accordance with the disclosure.

FIG. 5 is a flowchart for a method for diagnosing abnormal combustion in an engine in accordance with the disclosure.

### DETAILED DESCRIPTION

This disclosure relates to internal combustion engines and, more particularly, to the diagnosis of abnormal combustion in the engine on a continuous, real-time basis while the engine is operating in the field, whether such engine is operating in mobile or stationary applications in land- or marine-based applications. The systems and methods for diagnosing the quality of combustion are applicable to any type of engine and are not limited to the embodiments described herein. Accordingly, the present disclosure draws on an exemplary compression ignition or diesel engine for purpose of illustration, but the general concepts underlying the illustrated diagnostic systems and methods are applicable to spark-ignition gasoline engines, natural gas engines, compression-ignition engines, engines operating with two or more fuels, and the like. For example, the principles disclosed herein can be applied to gas engines that include a spark plug and an associated spark timing signal similar to a fuel injector timing signal on a diesel engine. The spark timing signal can be used in the same way as the diesel injector timing signal as described in the present disclosure. Moreover, the principles can be applied to other engine variants such as engines that include a prechamber that ignites a small portion of fuel and then injects the burning mixture into the larger engine cylinder, or a gas engine that premixes gas and air in the intake manifold and/or intake ports, and the like.

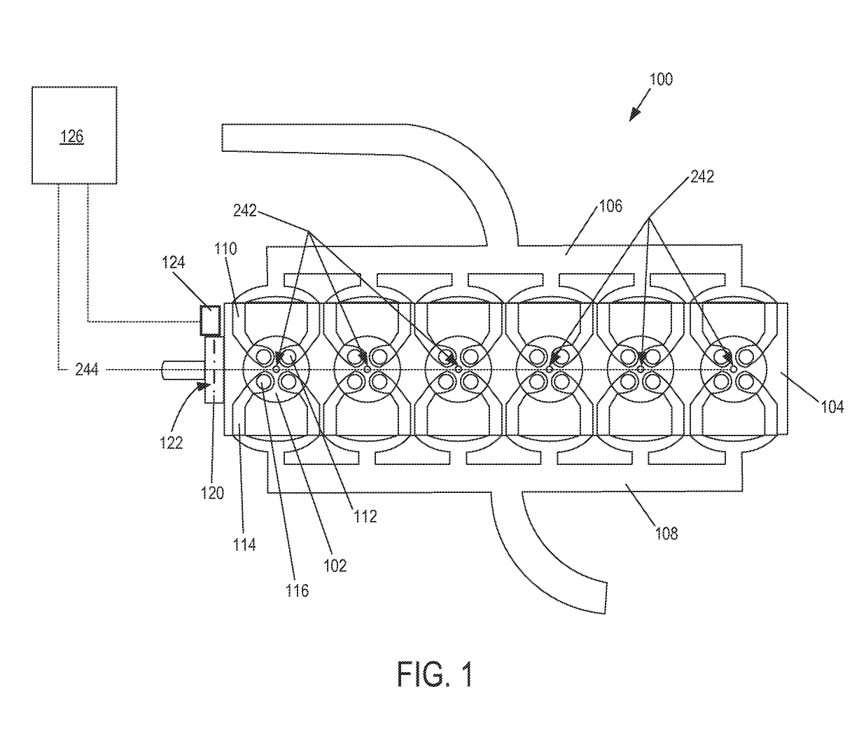

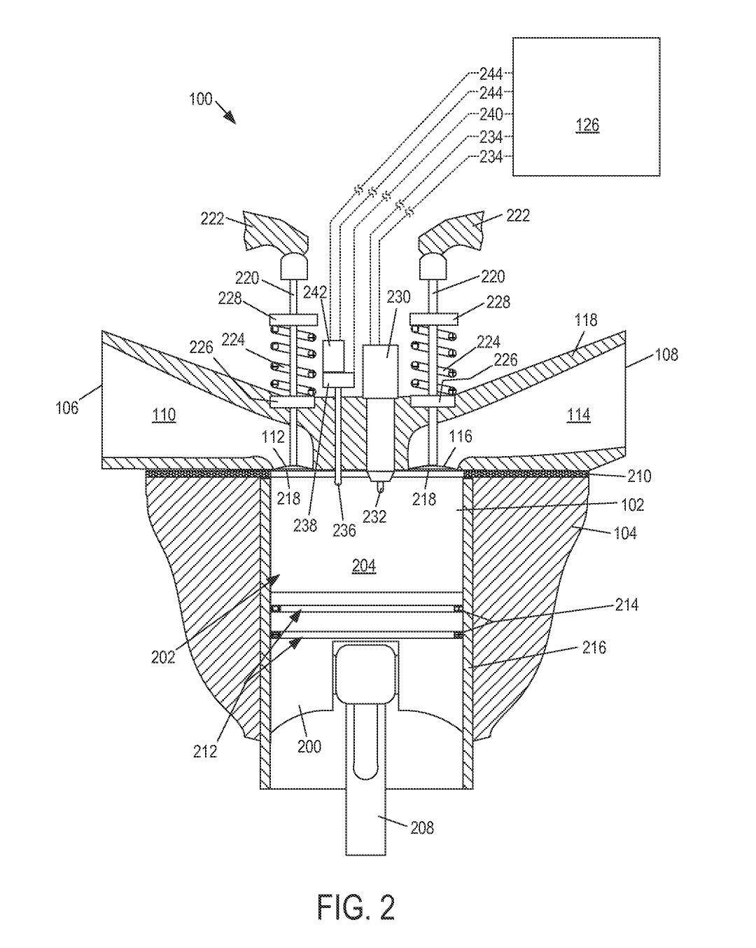

A block diagram of an engine 100 having a combustion cylinder 102 formed within a cylinder block 104 is shown in FIG. 1. A shown, the engine includes a plurality of combustion cylinders such as the combustion cylinder 102. A detailed, enlarged view of a combustion cylinder 102 of the engine 100 (FIG. 1) is shown in cross section in FIG. 2. In the two illustrations of FIGS. 1 and 2, same or similar elements and features are denoted by the same reference numerals for simplicity.

The engine 100 includes an intake manifold 106 and an exhaust collector 108 in fluid communication with each combustion cylinder 102. In the illustrated embodiment, the intake manifold 106 fluidly communicates with each combustion cylinder 102 via intake runners 110 that are fluidly connectable to each combustion cylinder 102 when a corresponding one of the intake valves 112 is open. Similarly, the exhaust collector 108 is connectable with each combustion cylinder 102 via exhaust runners 114 through exhaust valves 116. As shown in FIG. 2, the intake runners 110 and exhaust runners 114 are at least partially formed within a cylinder head 118, but any one of a number of other known engine configurations may be used.

Each combustion cylinder 102 includes a piston 200 that is configured to reciprocate within a bore 202. The portion of the bore 202 between the piston 200 and the cylinder head 118 defines a combustion chamber 204 that is generally sealed when combustion of an air/fuel mixture occurs. Air for the air/fuel mixture, which may further include other fluids such as exhaust gas, and/or a gaseous fuel, is provided to the combustion chamber 204 generally through the intake runners 110. Fuel is provided to the combustion chamber from an injector 230, which in the illustrated embodiment is configured to directly inject fuel into the chamber. In different engines or in alternative embodiments, the injector or another fuel delivery valve may be located elsewhere in the engine such that fuel and air are premixed before being provided to the combustion chamber 204.

When in the combustion chamber 204, the air/fuel mixture is compressed as the piston 200 moves to reduce the volume of the combustion chamber 204 until combustion occurs. Following combustion, exhaust gas remaining in the combustion chamber 204 is evacuated into the exhaust collector 108 through each of the exhaust valves 116. The reciprocal motion of the piston 200 is transformed to rotary motion of a crankshaft 120 (FIG. 1). The crankshaft 120, which is typically connected to the piston 200 via a connecting rod 208 (FIG. 2), includes indicia or other features 122 that are detectable by a crankshaft position sensor 124 (FIG. 1) during operation. Information or signals from the crankshaft position sensor 124 are provided to an electronic controller 126. The information on the angle of the crankshaft 120 can be directly correlated to the position of the piston 200 within the cylinder. The quality of the sealed containment of the air/fuel combustion mixture within the combustion chamber 204, various environmental factors, as well as fuel quality, fuel constituents (especially for gas engines), and accuracy in the fuel delivery of the fuel system, among other factors, have been known to affect the efficiency and quality of engine operation, and especially the timing of compression ignition and the burn duration and intensity of the fuel burning in the combustion chamber 204 during engine operation.

In the illustrated embodiment, various engine components contribute to the various sealing functions provided to the combustion chamber 204 during operation. As is shown in FIG. 2, a head gasket 210 is sealably positioned along the interface between the cylinder block 104 and the cylinder head 118 such that leakage of fluids is minimized along that interface. The piston 200 includes a plurality of piston ring grooves 212 (two shown) along its outer periphery. Each of the piston ring grooves 212 includes a piston ring seal 214 that radially, slidably, and generally sealably engages the inner wall of the bore 202. Although the bore 202 against which the piston ring seal 214 slides may be formed directly into the cylinder block 104, the engine 100 is shown in FIG. 2 to include a cylinder sleeve 216 within which the bore 202 is defined.

The intake valves 112 and the exhaust valves 116 are poppet-style valves forming seats that fluidly block the intake runners 110 and the exhaust runners 114, respectively, from the combustion chamber 204 when the intake valves 112 and the exhaust valves 116 are closed. Accordingly, each of the intake valves 112 and the exhaust valves 116 forms a poppet portion 218 that sealably engages a corresponding seat formed in the cylinder head 118. Each of the intake valves 112 or each the exhaust valves 116 includes a stem portion 220 connected to the poppet portion 218. The stem portion 220 includes a ball and socket connection arrangement with a valve bridge 222 (partially shown). Rocking motion of the valve bridge 222 causes the opening and closing of the intake valves 112 and the exhaust valves 116, as is known. A spring 224 disposed between a guide 226 and a retainer 228 biases each of the intake valves 112 or each of the exhaust valves 116 towards a closed position. Although one configuration for the structure, installation and actuation of each of the intake valves 112 and the exhaust valves 116 is shown herein, any other appropriate configuration may be used, such as selective of variable activation.

In the illustrated embodiment, a fuel injector 206 includes a nozzle tip 232 disposed in fluid communication with the combustion chamber 204 and configured to selectively inject an amount of fuel into the combustion chamber 204 during operation. The fuel injected by the nozzle tip 232 mixes with air, a mixture of air with exhaust gas, and/or a mixture of air with a gaseous fuel that is present in the combustion chamber 204 to form a combustible mixture that is compressed before combustion in the known fashion. The injection of fuel from the injector 230 can be accomplished by providing an appropriate injection signal to the injector from the electronic controller 126 via injector communication conduits 234.

In the particular exemplary embodiment shown in FIG. 2, the engine 100 is a diesel engine. Accordingly, when operating or starting the engine under certain conditions, such as cold start conditions, a glow plug 236 can be disposed in fluid contact with the combustion chamber 204 to warm the air/fuel mixture in the combustion chamber 204 and thus aid in initiating burning of the combustible mixture. More specifically, the glow plug 236, which is an electrically operated heater, can provide thermal energy to the air/fuel mixture in the combustion chamber 204, thus reducing the flash point or ignition temperature of the mixture to aid in engine operation, especially under cold start engine operating conditions. The glow plug 236 as shown is connected to an actuator 238 that activates the device in response to a signal from the electronic controller 126 that is provided via a glow plug communication line 240.

In the illustrated embodiment, the presence and position of the glow plug 236 in direct contact with the combustion chamber 204 is exploited to provide an input indicative of the pressure of fluids within the combustion chamber 204. In this way, the glow plug 236 is slidably but sealably connected to the cylinder head 118 and communicates forces to a pressure sensor 242, which in the illustrated embodiment is connected on an external side of the glow plug 236. Alternatively, it is contemplated that the pressure sensor 242 may be directly connected to sense cylinder pressure without an intervening structure such as the glow plug as shown herein. In one embodiment, the pressure sensor 242 may use a combination of a piezoresistive element and a strain gage, which together provide signal indicative of cylinder pressure. The pressure sensor 242 may otherwise be constructed by any appropriate and known method, such as those including piezoelectric elements, optical devices, strain devices, and others. Alternatively, the pressure sensor 242 may be connected in direct fluid communication with the combustion chamber 204.

Regardless of the type and positioning employed for the installation of the pressure sensor 242, a signal directly indicative of the pressure, in real time, of fluids within the combustion chamber 204 is provided to the electronic controller 126 via pressure signal communication lines 244. Certain sensor configurations, such as those sensors using piezoelectric elements, may be further configured to provide a signal indicative of vibration experienced by the sensor, for example, when intake or exhaust valves close, during engine operation.

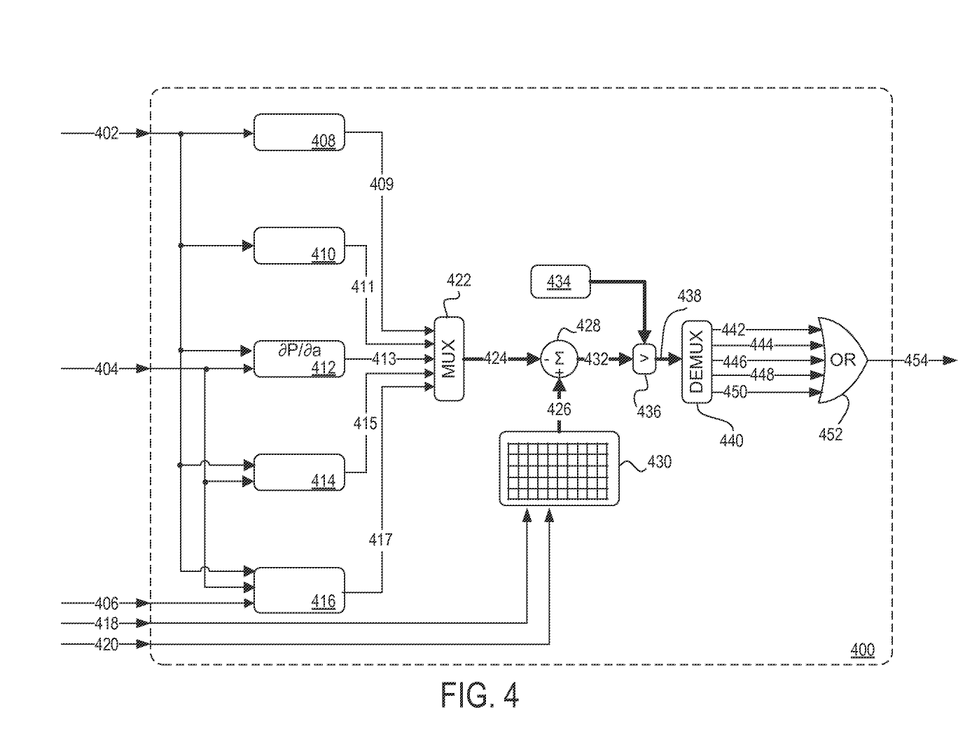

The electronic controller 126 may be a single controller or may include more than one controller disposed to control various functions and/or features of a machine. For example, a master controller, used to control the overall operation and function of a vehicle, machine or stationary application may be cooperatively implemented with an engine controller used to control the engine 100. In this embodiment, the term “controller” is meant to include one, two, or more controllers that may be associated with the engine 100 and that may cooperate in controlling various functions and operations. The functionality of the controller, while shown conceptually in FIG. 4 to include various discrete functions for illustrative purposes only, may be implemented in hardware and/or software without regard to the discrete functionality shown. Accordingly, various interfaces of the controller are described relative to components of the engine in the block diagram of FIG. 1. Such interfaces are not intended to limit the type and number of components that are connected.

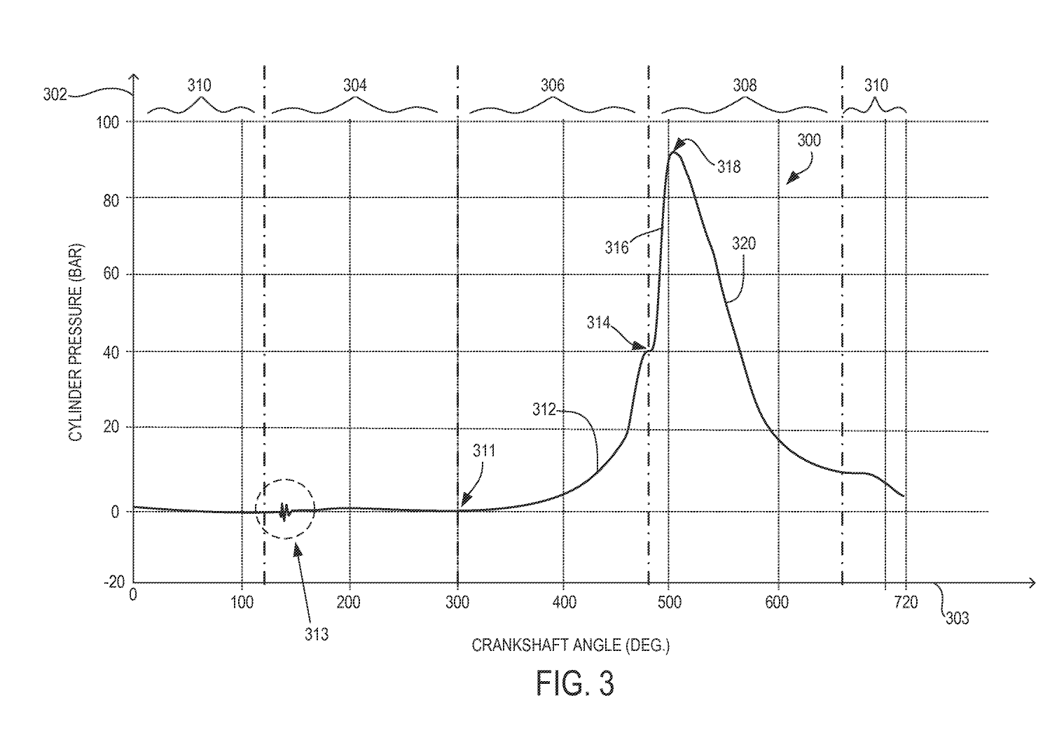

A sample cylinder pressure trace 300 is shown in FIG. 3. The sample cylinder pressure trace 300, in the typical fashion, is a plot of a pressure 302 within an engine cylinder that is plotted with respect to crankshaft angle 303. In a four-stroke engine, such as the engine 100 (FIG. 1), a complete cylinder cycle spans over two complete crankshaft revolutions, which is represented in FIG. 3 by 720 degrees of crankshaft rotation. In these two revolutions, four strokes are represented that include an intake stroke 304, a compression stroke 306, a combustion stroke 308, and an exhaust stroke 310. The compression stroke 306, which may span less than 180 degrees of crankshaft rotation depending on the timing for opening and closing the intake and/or exhaust valves, generally involves closing the combustion chamber and moving the piston deeper into the bore to compress fluids found therein, as previously described. In the sample cylinder pressure trace 300, the pressure increase due to the compression of the fluid by the cylinder is represented by segment 312, which begins at a compression initiation point 311 and increases up to a pressure representing a piston position close to the top dead center (TDC) position, i.e., the maximum depth displacement of the piston within the cylinder. This pressure increase is due to the mechanical compression of the fluids within the engine cylinder.

Ignition of the fluids within the cylinder occurs or is carried out close to or at the TDC position, and is represented on the sample cylinder pressure trace 300 by ignition point 314. Following ignition point 314, there is a substantial pressure increase in the combustion chamber represented by segment 316, which extends from the ignition point 314 up to a peak cylinder pressure 318. This pressure increase is due to the rapid expansion of the burning material within the engine cylinder. Although the burning material within the cylinder is expanding, the piston is also pushed downwards as it carries out the combustion stroke 308 so that cylinder pressure begins to drop over segment 320, which may also extend into the exhaust stroke 310. The presence of an abnormal combustion condition would be apparent from the cylinder pressure trace during operation. For example, a misfire would not produce the pressure increase due to combustion over segment 316. Similarly, a detonation or knocking, as it is sometimes referred, would produce a rough portion in the pressure trace that is indicative of pressure waves present within the combustion chamber. Late ignition would produce a shifted trace, and so on.

In the accordance with the present disclosure, by monitoring cylinder pressure during engine operation, and especially during combustion, various operating parameters of the engine and the combustion process can be inferred or estimated, which can then cause changes in the operating mode of the engine to promote operating efficiency and help diagnose or prognose engine failures or inefficiencies. In the embodiments described below, such diagnosis or prognosis can be carried out in real time and while the engine operates in the field, which is a significant advancement over previously implemented diagnostic testing, which was carried out while the engine was taken out of service for maintenance. By measuring, monitoring and/or analyzing in-cylinder pressure in real time, the systems and methods described in the present disclosure can provide first-hand combustion information.

Parameters such as peak cylinder pressure, maximum pressure rise in the cylinder, detonation amplitude and/or frequency, crankshaft angle at the start of combustion, crankshaft angle at the center of combustion, and other parameters, can be observed or calculated directly for each cylinder and from each cylinder's pressure measurement in at least one or more software loops during engine operation. Using a control software, such information can be processed such that the measured or observed values for various combustion parameters are compared to theoretical, expected or commanded values. At times when the measured or observed parameters differ from the corresponding theoretical, expected or commanded values by more than a predetermined diagnostic threshold difference, the system can report and record a combustion problem, which can be used to withdraw the engine from service and/or address any issues present on the engine when the engine is undergoing scheduled maintenance. When detecting abnormal combustion conditions, the engine control software can mitigate any abnormal conditions while the engine is operating and without requiring the engine to be removed from service. For example, in one embodiment, if pre-ignition is observed, which includes the detection of ignition that is earlier than a commanded fuel injection or spark timing, the engine operation may be adjusted to change the fuel injection or spark timing according to the period of pre-ignition that was observed in an effort to rectify the situation without intruding on the operator's use of the engine.

Apart from the pressure of the operating fluids within the combustion chamber, the pressure sensors used in certain engines can also be useful in detecting the opening and closing events of the various valves associated with each combustion chamber, for example, intake valves and exhaust valves. In one embodiment, vibrations caused by the closing of an intake or exhaust valve, as each valve contacts its respective valve seat under force from a closing spring or a closing actuator, can be detected by the cylinder pressure sensor, for example, a piezoelectric sensor, as a vibration. An exemplary wave or vibration that may be sensed by the pressure sensor is illustrated as vibration 313 in FIG. 3. In one contemplated embodiment, the frequency, amplitude and time of occurrence of the vibration 313 in terms of crankshaft angle can be monitored in addition to the various engine combustion parameters to determine the timing for opening and closing of the intake and exhaust valves, which is especially useful in engines having variable valve timing control for all cylinders together or for each cylinder separately. By monitoring the cylinder pressure signal with sufficient resolution, in one embodiment, the frequency and amplitude of the valve closing event can be used to calculate valve closing force, which is indicative of valve lash, and other mechanical aspects of valve operation. These parameters can also be compared with predetermined thresholds to determine whether a variable valve opening and closing system is operating properly.

A block diagram for an engine control 400 configured to monitor engine combustion, diagnose abnormal combustion conditions, and mitigate such conditions is shown in FIG. 4. The engine control 400 is configured to receive various inputs and provide various outputs during operation, and may be operating within the electronic controller 126 as shown in FIG. 1. Relevant to the present disclosure, certain inputs and outputs are discussed, but additional and/or different inputs and outputs than those discussed may be used. In the illustrated embodiment, a cylinder pressure signal 402 indicative of the cylinder pressure, measured directly and in real time during engine service in the field from within an engine cylinder is provided to the engine control 400. As previously discussed, for example, relative to engine 100 (FIG. 1), more than one combustion cylinder 102 may be present. Although a single, cylinder pressure signal 402 is shown in FIG. 4, it is contemplated that more than one input may be present when an engine includes more than one cylinder having instrumentation for monitoring pressure as generally described herein.

The engine control 400 may further receive an engine timing signal 404 that is indicative of the rotational orientation or angle of the engine crankshaft in real time. The engine timing signal 404 may be actually provided by sensors associated with the engine crankshaft, camshaft, flywheel, another rotating engine component, or a combination of more than one signals indicative of the rotation of one or more of these or other rotating components associated with the engine. In the illustrated embodiment, the engine timing signal 404, which may be expressed in degrees of crankshaft or camshaft rotation, is in time-aligned relation to the cylinder pressure signal 402 such that a pressure and angle provided to the engine control 400 are provided concurrently and represent the then-present conditions in the cylinder being monitored. In the illustrated embodiment, the engine timing signal 404 may be provided by the crankshaft position sensor 124 (FIG. 1) that is associated with the engine crankshaft, or another sensor that is similarly associated with another rotating engine component such as a camshaft, which can provide signals indicative of the angular position of the engine's crankshaft or a derivative thereof, in real time during engine operation. It is noted that the engine timing signal 404 may be operating regardless of whether the engine is operating to produce power or whether the engine is motored, for example, by use of a starter motor, when the engine is decelerating without fuel being provided to the engine's cylinders or, in accordance with one embodiment, when fuel is selectively cut off to the cylinder during a deceleration or engine-braking operation. An ignition timing signal 406, which is indicative of at least the timing of a commanded or actual fuel injection, spark ignition, or other engine ignition parameter, is also provided.

The cylinder pressure signal 402, engine timing signal 404, and ignition timing signal 406, are provided and processed in various sub-modules of the engine control 400 to determine various combustion characteristics and attributes, in real time. In the embodiment shown, various determinations of the operation of the engine in terms of combustion are discussed, but it should be appreciated that additional or fewer parameters may be included depending on the particular engine or engine application that is considered. In the illustrated embodiment, the cylinder pressure signal 402 is provided to a detonation determinator 408. The detonation determinator 408 as shown includes a comparator function that compares the pressure signal with a pressure band that comprises a lower cylinder pressurization threshold pressure and an upper pressure value. The detonation determinator may further include a transform, model function, or other algorithm that can determine the amplitude and/or frequency of pressure fluctuations within the combustion chamber, and compare those parameters with respective threshold values. When the cylinder pressure signal 402 indicates that a cylinder is pressurized, i.e., when the lower pressurization threshold pressure has been reached, but the pressure value, which is indicative of a burning of the fuel/air mixture in the cylinder, has not been reached, the detonation determinator 408 may determine that a misfire and/or detonation is present and provide a misfire signal 409.

The engine control 400 further includes a peak pressure determinator 410. The peak pressure determinator 410 may be a comparator that compares a maximum cylinder pressure reached in the cylinder, as indicated by monitoring the cylinder pressure signal 402, with a peak cylinder pressure threshold, which is more than the upper pressure value used in the detonation determinator 408. When the cylinder pressure signal 402 indicates that the peak cylinder pressure is outside of an acceptable band of peak pressures, for example, within 10% of an expected peak cylinder pressure, then the peak pressure determinator 410 may provide a peak pressure signal 411, which indicates that an abnormal combustion may be occurring which generates peak cylinder pressures that are too high, or too low.

The cylinder pressure signal 402, along with the engine timing signal 404 are further provided to a pressure rise determinator 412. Pressure rise within the cylinder can sometimes be monitored to infer the rate of burning of the fuel provided to the cylinder. In the illustrated embodiment, the pressure rise determinator 412 may operate to calculate a parameter related to the derivative of an increase in the cylinder pressure signal 402 with respect to crank angle, as indicated by the engine timing signal 404, in the form of ∂P/∂α, where P indicates cylinder pressure and α indicates angle of crank rotation. Any suitable algorithm may be used to calculate this derivative, including a difference calculation of the ratio between a difference in pressure rise over a difference in engine crank angle. The pressure rise determinator 412 thus determines a pressure rise signal, which the determinator provides as a pressure rise signal 413.

The engine control 400 further includes a combustion initiation determinator 414, which receives at least the cylinder pressure signal 402 and the engine timing signal 404. The combustion initiation determinator 414 continuously compares the cylinder pressure with the then-present timing to determine a sharp rise in cylinder pressure, which is indicative of a burn initiation or ignition of the fuel within the cylinder. When ignition is detected, the combustion initiation determinator 414 selects the crank angle corresponding to the ignition detected and provides an actual ignition signal 415. In a somewhat related determination, the engine control 400 further includes a center of combustion determinator 416, which based on the cylinder pressure signal 402, the engine timing signal 404, and the ignition timing signal 406, which is optional, determines the median angle of combustion over a combustion range or duration in the engine, and provides a center of combustion indication signal 417. Apart from the various combustion parameters discussed herein, other combustion parameters may also be used. For example, the controller can determine the ignition mean effective pressure (IMEP), the maximum heat release rate of the fuel burn, and other parameters.

For all the determinations and signals provided, as discussed above, the engine control 400 receives information of the then present engine speed 418 and engine load 420, which may be a commanded or an actual load. The various signals, i.e., the misfire signal 409, peak pressure signal 411, pressure rise signal 413, actual ignition signal 415, and center of combustion indication signal 417, are optionally provided to a multiplexer 422 or are alternatively separately analyzed. Each of these signals 424 is compared to a corresponding expected parameter 426 in a summing junction 428. Although the summing junction 428 is shown as a subtractor function here, any other known method for comparing parameters can be used. For example, the summing junction 428 may include an addition function, other mathematical functions, filtering, debouncing, averaging, and the like. In the exemplary embodiment shown here, a table 430, which includes tabulated values of expected parameters of the engine for each of the parameters measured or monitored in the signals 424 for a given engine speed 418 and engine load 420, provides the particular expected value that corresponds to each signal such that a series of differences 432 can be calculated at the summing junction 428.

Each of the differences 432 is compared with a corresponding threshold limit 434 at a comparator 436 to determine if a fault 438 is present. The comparator 436, which is generically shown to include a “greater than” notation, may include any other mathematical comparison function, and may alternatively include other types and/or combinations of logic and mathematical functions configured to infer or determine the presence of the fault 438. The fault 438 is provided to a de-multiplexer 440 to yield specific faults that may be present. The specific faults may include a misfire 442, which corresponds to the misfire signal 409, a loss of cylinder pressure 444, which corresponds to the peak pressure signal 411, an abnormal burn rate 446, which corresponds to the pressure rise signal 413, a pre-ignition 448, which corresponds to the actual ignition signal 415, and an early or late combustion fault 450, which corresponds to the center of combustion indication signal 417. All these faults are provided to an OR gate 452 such that the presence of at least one fault will activate a fault flag 454. The fault flag 454 may be used to alert the machine operator of a fault, for example, by illuminating a lamp or a message alerting the operator of a fault, and/or may additionally be used to automatically mitigate the fault by changing engine operation, to the extent feasible, to address the fault condition. For example, an indication of a pre-ignition as indicated by the pre-ignition 448 provided based on the actual ignition signal 415, may cause a pre-determined ignition delay, for example, an injection delay, to be implemented for a predetermined number of engine cycles and by a predetermined timing angle. If the pre-ignition persists, or is improved, the ignition timing may be maintained or be further adjusted until a maximum delay is reached.

### INDUSTRIAL APPLICABILITY

The present disclosure is applicable to internal combustion engines of any type and for any application. In the illustrated embodiments, the engine described is shown as having a pressure sensor associated with each engine cylinder. In alternative embodiments, depending on the type of abnormal combustion being diagnosed and/or addressed, pressure sensors can be used in one or, at least, in fewer than all engine cylinders. For example, for an engine having uniform performance in the various cylinders, if an abnormal combustion condition that may be caused by factors that are not specific to the engine hardware present in the cylinder monitored, then a single pressure sensor may be installed in a representative engine cylinder for monitoring of all engine cylinders. Alternatively, more than one pressure sensor may be used in the same engine cylinder.

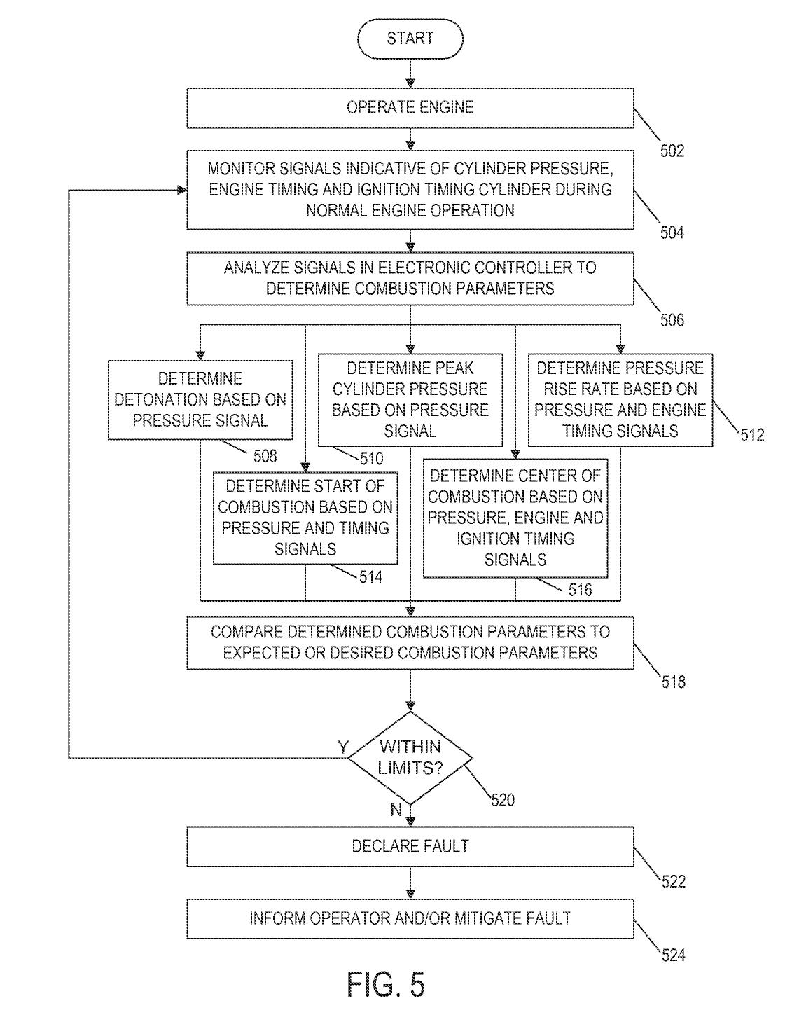

The systems and methods described herein are applicable for various engine diagnostic tests that are performed in real time and during normal operation of the engine. A flowchart for a method of diagnosing the condition of various abnormal engine operating conditions is shown in FIG. 5. At the outset, the method includes operating the engine during normal service at 502. While the engine is operating, various operating parameters including signals provided by appropriate sensors or various controllers of the engine are acquired and monitored, including monitoring cylinder pressure, engine timing, and a desired or commanded ignition timing at 504. During engine operation, and for a particular engine speed and load combination, for which parameters may also be monitored, the various signals are analyzed using an electronic controller associated at least with the engine to determine various combustion parameters at 506.

In the illustrated embodiment, the controller determines the occurrence of a detonation of fuel within the cylinder based on the pressure signal at 508. The controller further determines a peak cylinder pressure based on the pressure signal at 510. The pressure rise rate is further determined based on the pressure signal and also on the engine timing signal by the controller at 512. The controller further determines the start of combustion based on cylinder pressure and engine timing signals at 514, and also determines the center of combustion based on the cylinder pressure and the engine and ignition timing signals at 516. It should be appreciated that fewer or more of these engine parameters based on these or additional engine operating signals may also be determined based on the particular needs and operating parameters of each engine application.

As the various combustion parameters are determined, in real time and on a continuous basis during normal engine operation, each of the parameters is compared to a corresponding expected or desired combustion parameter for the engine's particular speed and load operating point at 518. In one embodiment, a difference or divergence of each parameter with a corresponding expected or desired value for that parameter, which is tabulated for the engine speed and load operating point of the engine, is calculated. The difference is compared to a threshold that corresponds to the parameter being considered at 520 and, when the difference exceeds the difference threshold, a fault signal is provided 522. The fault signal may be used to inform a machine operator that a fault exists and, additionally or alternatively, cause a fault mitigation process to be undertaken at 524. When no fault exists, the process continues during engine operation. In one embodiment, the mitigation process to be undertaken at 524 may be carried out before the fault signal is provided at 522.

In one optional embodiment, depending on the type of condition that is diagnosed, the controller may allow the engine to operate but at a reduced power output mode such that further damage to engine components may be avoided while the engine is scheduled for service or repair. Additional examples of mitigation measures include disabling gas or diesel fuelling in engines equipped with dual fuels, changing diesel injector and/or spark plug timing angles, changing gas and/or diesel injection quantities, and others. In another optional embodiment, an intrusive test during which the fuel provided to one or more cylinders is cut off during engine operation may be carried out. In such embodiment, fuel would continue to be supplied as normal to other cylinders while the particular cylinder cycling without fuel is motored. In this way, the motoring pressure can be monitored at different conditions. As a refinement to this embodiment, the engine may be run at a specific more than one operating condition, for example, a service test, such that cylinder operation can be examined under different operating conditions in a troubleshooting or maintenance environment.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. An engine, comprising:
a cylinder having cylinder bore formed in a cylinder block;
a piston reciprocally disposed within the cylinder bore;
a crankshaft connected to the piston such that reciprocal motion of the piston will result in rotational motion of the crankshaft;
one or more piston ring seals connected to the piston and disposed between the piston and the cylinder bore to sealably and slidingly engage the cylinder bore, and a cylinder head disposed to block an open end of the cylinder bore such that a combustion chamber is defined within the cylinder bore between the piston and the cylinder head;
a pressure sensor disposed to sense a cylinder pressure within the combustion chamber and provide a pressure signal, which is indicative of the cylinder pressure;
an engine timing sensor disposed to sense an angle of a rotating component of the engine and provide an engine timing signal, which is indicative of a position of the piston within the cylinder bore; and
an electronic controller programmed to:
receive the pressure signal from the pressure sensor;
receive the engine timing signal from the engine timing sensor;
analyze the pressure signal and the engine timing signal to determine at least one of a misfire signal, a peak pressure signal, a pressure rise rate, an actual ignition signal, and a center of combustion signal; and
activate a fault flag when the at least one of the misfire signal, the peak pressure signal, the pressure rise rate, the actual ignition signal, and the center of combustion signal, indicates that an abnormal combustion is present in the cylinder.

2. The engine of claim 1, further comprising a fuel injector disposed to inject fuel into the cylinder in response to an injection command signal provided by the electronic controller to the fuel injector, the injection command signal being associated with a particular engine timing that is expected to produce an ignition of the fuel at an ignition time, wherein at least the center of combustion signal further depends on the injection command signal.

3. The engine of claim 1, wherein determining the misfire signal, the peak pressure signal, the pressure rise rate, the actual ignition signal, and the center of combustion signal, further depends on an engine speed signal and an engine load signal.

4. The engine of claim 3, wherein the electronic controller further includes therein a table, which includes tabulated values of expected parameters for each of the misfire signal, the peak pressure signal, the pressure rise rate, the actual ignition signal, and the center of combustion signal for a given engine speed and engine load, and wherein the table provides a particular expected value corresponding to each signal.

5. The engine of claim 4, wherein the electronic controller is further configured to calculate a difference between each of the misfire signal, the peak pressure signal, the pressure rise rate, the actual ignition signal, the center of combustion signal, and a corresponding particular expected value for each, to yield a corresponding difference, and further compares the corresponding difference with a corresponding threshold value.

6. The engine of claim 5, wherein the fault flag is activated when the corresponding difference exceeds the corresponding threshold value.

7. The engine of claim 1, wherein the misfire signal is determined in a detonation determinator within the electronic controller, the detonation determinator including a comparator function that compares the pressure signal with a pressure band that comprises a lower cylinder pressurization threshold pressure and an upper pressure value such that, when the pressure signal indicates that the cylinder is pressurized, the detonation determinator may determine that a misfire is present and provide the misfire signal.

8. The engine of claim 1, wherein the peak pressure signal is determined in a peak pressure determinator, the peak pressure determinator including a comparator function that compares a maximum cylinder pressure reached in the cylinder, as indicated by the pressure signal, with a peak cylinder pressure threshold such that, when the pressure signal indicates that the maximum cylinder pressure reached in the cylinder is outside of an acceptable band of peak pressures, the peak pressure determinator provides the peak pressure signal, which indicates that the abnormal combustion may be occurring which generates peak pressures in the cylinder that are too high or too low.

9. The engine of claim 1, wherein the pressure rise rate is determined in a pressure rise determinator, which calculates a parameter related to a derivative of an increase in the pressure signal with respect to the angle, as indicated by the engine timing signal, in a form of ∂P/∂α, where P indicates the cylinder pressure and α indicates the angle.

10. The engine of claim 1, wherein the actual ignition signal is determined in a combustion initiation determinator, which receives at least the pressure signal and the engine timing signal, and wherein the combustion initiation determinator operates to continuously compare the cylinder pressure with a then-present engine timing to determine a sharp rise in the cylinder pressure, which is indicative of a burn initiation or ignition of fuel within the cylinder.

11. The engine of claim 1, wherein the center of combustion signal is determined in a center of combustion determinator, which, based on the pressure signal, the engine timing signal, and an ignition timing signal, determines a median angle of combustion over a combustion range or duration in the engine, and provides the center of combustion signal.

12. The engine of claim 1, further comprising a plurality of cylinders, each of the plurality of cylinders including a corresponding pressure sensor such that the electronic controller receives and analyzes a plurality of pressure signals, wherein the electronic controller is further configured to activate a corresponding fault flag with respect to each of the plurality of cylinders separately during normal engine operation.

13. A method for diagnosing an abnormal combustion in a cylinder of an engine, comprising:
monitoring a pressure signal from an engine pressure sensor, which is indicative of a fluid pressure within a combustion chamber of the engine;
monitoring an engine timing signal from an engine timing sensor, which is indicative of a rotation of an output shaft of the engine and also indicative of a position of a piston within the cylinder;
receiving the pressure signal from the engine pressure sensor in an electronic controller;
receiving the engine timing signal from the engine timing sensor in the electronic controller;
analyzing the pressure signal and the engine timing signal using the electronic controller during normal engine operation to determine, in real time, at least one of a misfire signal, a peak pressure signal, a pressure rise rate, an actual ignition signal, and a center of combustion signal; and
activating a fault flag in the electronic controller when at least one of the misfire signal, the peak pressure signal, the pressure rise rate, the actual ignition signal, and the center of combustion signal, indicates that the abnormal combustion is present in the cylinder.

14. The method of claim 13, further comprising injecting fuel into the cylinder using a fuel injector and in response to an injection command signal provided by the electronic controller to the fuel injector, wherein the injection command signal is associated with a particular timing of the engine that is expected to produce an ignition of fuel at an ignition time, and wherein determining at least the center of combustion signal further depends on the injection command signal.

15. The method of claim 13, wherein determining the misfire signal, the peak pressure signal, the pressure rise rate, the actual ignition signal, and the center of combustion signal, further depends on an engine speed signal and an engine load signal that are monitored by the electronic controller.

16. The method of claim 15, further comprising storing a table in the electronic controller, the table including tabulated values of expected parameters for each of the misfire signal, the peak pressure signal, the pressure rise rate, the actual ignition signal, and the center of combustion signal for a given engine speed and engine load, and providing, based on the table, a particular expected value corresponding to each signal.

17. The method of claim 16, further comprising:
calculating, using the electronic controller, a difference between each of the misfire signal, the peak pressure signal, the pressure rise rate, the actual ignition signal, the center of combustion signal, and a corresponding particular expected value for each, to yield a corresponding difference; and
comparing the corresponding difference with a corresponding threshold value.

18. The method of claim 17, wherein activating the fault flag is accomplished when the corresponding difference exceeds the corresponding threshold value.

19. The method of claim 13, wherein the engine further comprises a plurality of cylinders, each of the plurality of cylinders including a corresponding pressure sensor such that the electronic controller receives and analyzes a plurality of pressure signals, wherein the electronic controller is further configured to activate a corresponding fault flag with respect to each of the plurality of cylinders separately during normal engine operation.

20. The method of claim 13, wherein, at least one of:
the misfire signal is determined in a detonation determinator within the electronic controller, the detonation determinator including a comparator function that compares the pressure signal with a pressure band that comprises a lower cylinder pressurization threshold pressure and an upper pressure value such that, when the pressure signal indicates that the cylinder is pressurized, the detonation determinator may determine that a misfire is present and provide the misfire signal;
the peak pressure signal is determined in a peak pressure determinator, the peak pressure determinator including an additional comparator function that compares a maximum cylinder pressure reached in the cylinder, as indicated by the pressure signal, with a peak cylinder pressure threshold such that, when the pressure signal indicates that the maximum cylinder pressure reached in the cylinder is outside of an acceptable band of peak pressures, the peak pressure determinator provides the peak pressure signal, which indicates that the abnormal combustion may be occurring which generates peak pressures in the cylinder that are too high or too low;
the pressure rise rate is determined in a pressure rise determinator, which calculates a parameter related to a derivative of an increase in the pressure signal with respect to crank angle, as indicated by the engine timing signal, in a form of ∂P/∂α, where P indicates a cylinder pressure and α indicates the angle;
the actual ignition signal is determined in a combustion initiation determinator, which receives at least the pressure signal and the engine timing signal, and wherein the combustion initiation determinator operates to continuously compare the cylinder pressure with a then-present engine timing to determine a sharp rise in the cylinder pressure, which is indicative of a burn initiation or ignition of fuel within the cylinder; and
the center of combustion signal is determined in a center of combustion determinator, which, based on the pressure signal, the engine timing signal, and an ignition timing signal, determines a median angle of combustion over a combustion range or duration in the engine, and provides the center of combustion signal.
